(19) United States
(12) Patent Application Publication
(10) Pub. No.: US 2008/0234850 A1
(43) Pub. Date: Sep. 25, 2008

(54) MODEL BASED DEFINITION INSTALLATION AND ASSEMBLY DRAWING PROCESS

(76) Inventors: William C. Bowling, Simi Vallley, CA (US); Tom Handler, North Hills, CA (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/687,708

(22) Filed: Mar. 19, 2007

(51) Int. Cl. G06F 19/00

(52) U.S. Cl. 700/98

(57) ABSTRACT

A software package defines installation and assembly requirements for a product through simplified representations of a 3D design model having a multiple of component parts which define the product in a data format different than that which created the 3D design model. Data created by the process replaces documentation supplied by traditional installation and assembly drawings. Documentation of the installations and assemblies is accomplished entirely electronically.

### BACKGROUND OF THE INVENTION

The present invention relates to a software package, and more particularly to a model based definition installation and assembly drawing system software which replaces documentation supplied by traditional installation and assembly release drawings to bridge product development with the creation of end user data.

Product development involves a variety of software and data systems. Conventional product development systems often include a mechanical engineering and design CAD tool such as Pro/Engineer which is capable of creating complex 3D models, assemblies, and 2D measured drawings. A typical Pro/ENGINEER software package includes different modules customizable to a customer's specific requirements. Pro/ENGINEER outputs include solid model data for tooling, rapid prototyping, CNC manufacturing, and finite element analysis.

Oftentimes, the full design model is proprietary or includes detailed information of a product unnecessary for later end users such as those who, for example, may be assembling or installing the product modeled by the originator. In such situations, 2D drawings are typically provided to the end user which include only the information required for that end user. Although effective, creation of such installation and assembly drawings particular to each end use is often time demanding and expensive. Furthermore, should the components of the product be updated, revised end user drawing sets which include the design updates must again be generated. This may delay product development.

Accordingly, it is desirable to provide a software package which facilitates integration of product development with the creation of end user data to minimize development time by conveying assembly and installation design intent in an unambiguous manner.

### SUMMARY OF THE INVENTION

The software package according to the present invention provides installation and assembly data for a product. Data created by this process replaces documentation supplied by traditional installation and assembly drawings. Documentation of the installations and assembly is accomplished entirely electronically.

In the absence of traditional release drawings, several data elements are generated for use by an assembly and installation end user. These data elements are released as part of Build-to, Buy-to, Supply-to, Package as an archived analog to a full drawing package to be managed collectively through procedural associativity. All data elements are generated from the same master design model data set.

Model Based Definition (MBD) encompasses two distinct areas of endeavor. There are those who prepare the data and there are those who consume the data. Some overlap exists. Preparation of the data is done with Pro/ENGINEER and the Joint Manager software suite of tools. Consumption or use of the data is enabled through the use of an end-user-application which facilitate access to the installation and assembly drawing data. Tools utilized with the end-user-application include database, HTML, and manipulatable 3-D assembly and installation models.

The present invention therefore provides a software package which facilitates integration of product development with the creation of end user data to minimize development time by conveying assembly and installation design intent in an unambiguous manner.

### BRIEF DESCRIPTION OF THE DRAWINGS

The various features and advantages of this invention will become apparent to those skilled in the art from the following detailed description of the currently disclosed embodiment. The drawings that accompany the detailed description can be briefly described as follows:

FIG. 1 is a general block diagram of a computer system for use with the present invention;

FIG. 2A is a flowchart generally depicting the steps performed with a model based definition installation and assembly drawing software system referred to herein as Joint Manager software package;

FIG. 2B is a chart describing components of the Joint Manager software package;

FIG. 3 schematically illustrates model relationships of the Joint Manager software package;

FIGS. 4A-4Y are representations of the HTML output provided by the Joint Manager software package illustrating each joint of the design model;

FIG. 5 is screen shot representations of an end-user application for use with the Joint Manager software package; and

FIGS. 6A-6C are representations of the database output provided by the Joint Manager software package illustrating

### DETAILED DESCRIPTION OF THE DISCLOSED EMBODIMENT

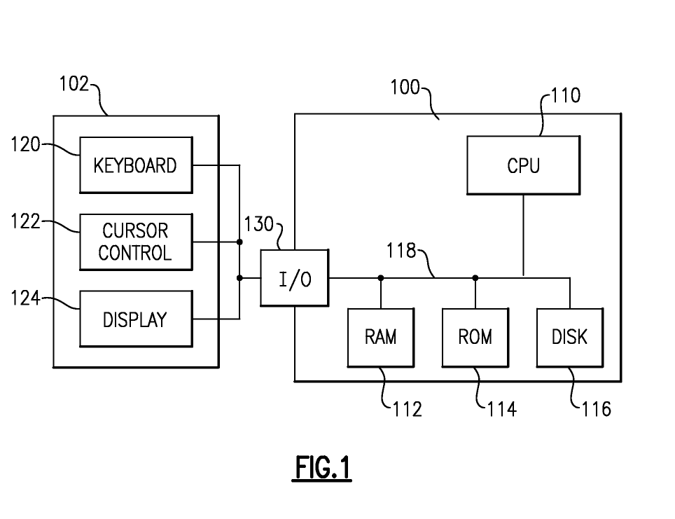

FIG. 1 is a block diagram illustrating an exemplary computer system of the type in which the present invention can be employed. The system includes a computer 100 connected to one or more external peripheral devices 102. The computer 100 includes a central processing unit 110, a main memory which is typically implemented in the form of a random access memory 112, a static memory that can comprise a read only memory 114 and a permanent storage device, such as a magnetic or optical disk 116.

The CPU 110 communicates with each of these forms of memory through an internal bus 118. The one or more peripheral devices 102 include, but are not limited to, a data entry device such as a keyboard 120, a cursor control device 122 such as a mouse, trackball, a pen and stylus, a touch-sensitive screen, a trackpad, a microphone, a joystick, a camera or the like, a display device 124 and, optionally, an audio device such as speakers (not shown). The display device 124, such as a CRT monitor or an LCD screen, provides a visual display of the information that is being processed within the computer. Each of these external peripheral devices communicates with the CPU 110 by one or more input/output ports 130 on the computer 100. Input/output ports 130 also allow the computer 100 to interact with a local area network server, an external network, such as the Internet, or an external storage device.

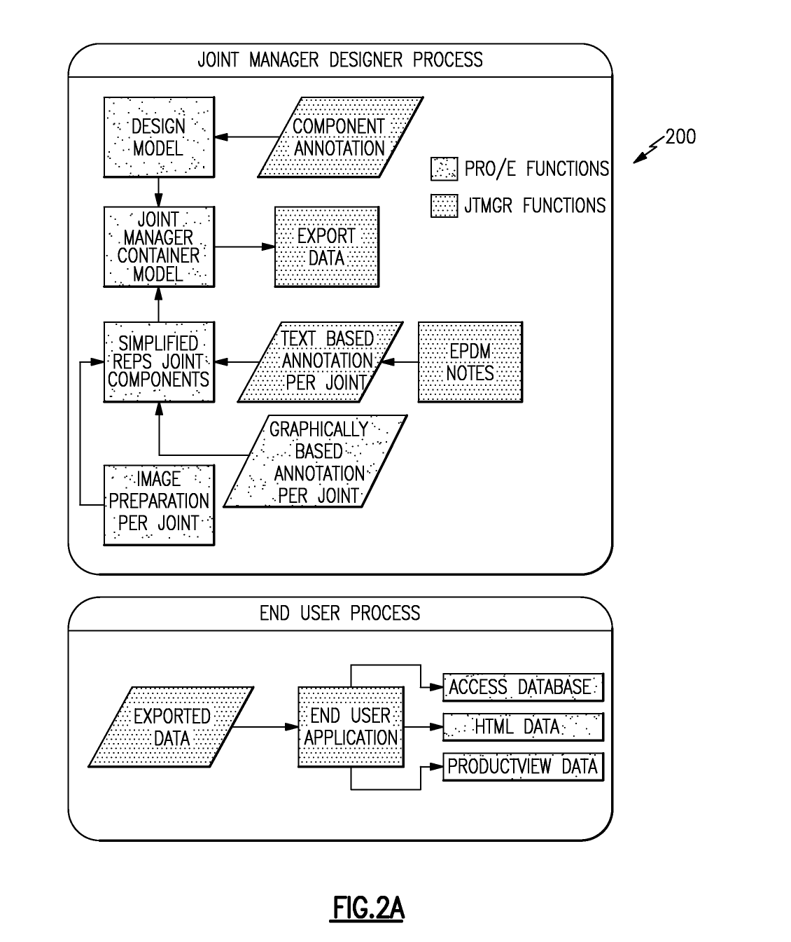

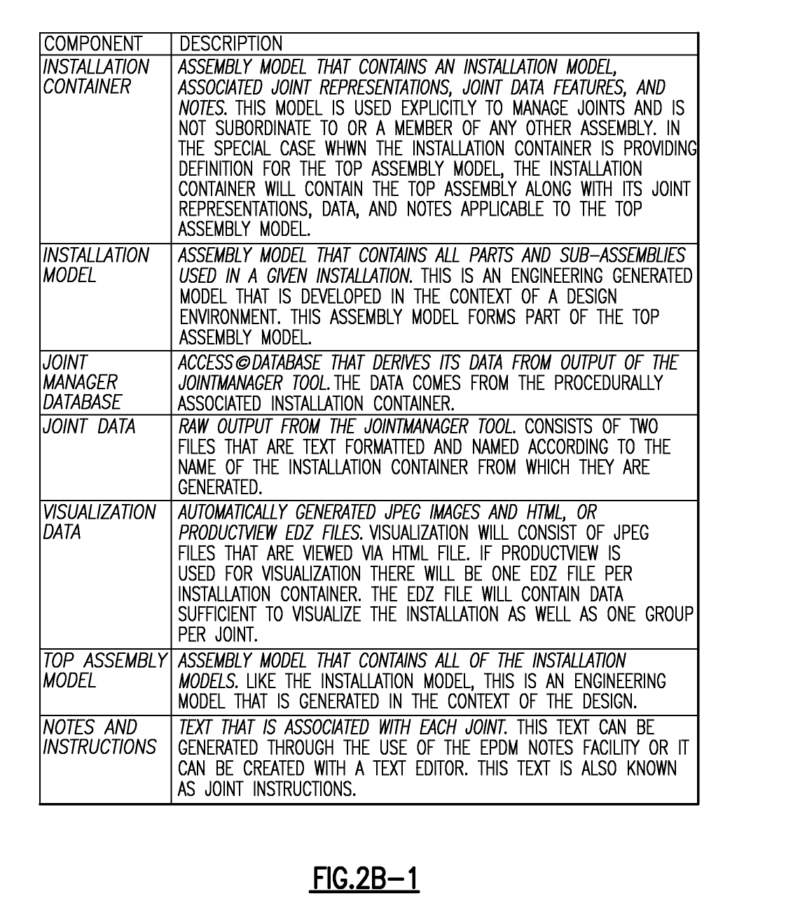

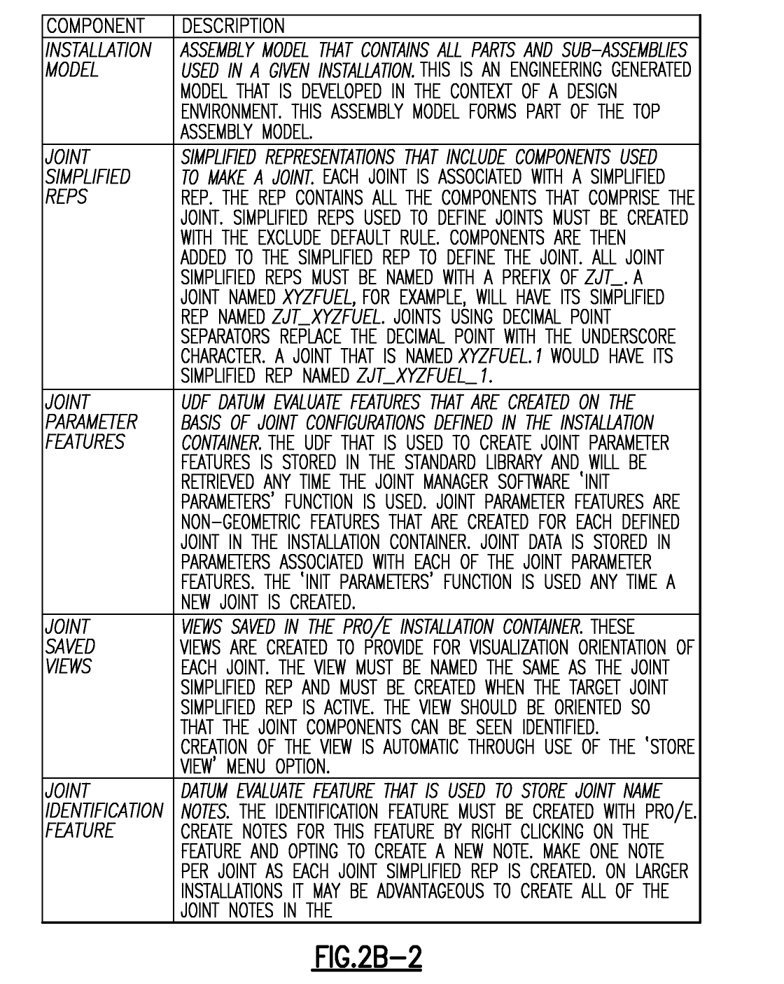

FIG. 2A is a process flowchart which illustrates a model based definition installation and assembly drawing software system 200 referred to herein as Joint Manager. The Joint Manager is implemented through computer readable software in conjunction with a mechanical engineering and design CAD tool software package capable of creating complex 3D models, assemblies, and 2D measured drawings such as that provided by the Pro/Engineer software package. The Pro/ENGINEER software package includes different modules, customizable to the customer's specific needs, and may include the model based definition installation and assembly drawing system of the present invention as a module or tool suite thereof. It should be understood that various other mechanical engineering and design CAD tools may be utilized herewith.

The Joint Manager functions are illustrated as clear boxes while the Pro/ENGINEER functions are illustrated as shaded boxes. Furthermore, the square boxes generally represent processes while the parallelogram boxes generally represent data. Several components are provided with Joint Manager (FIG. 2B). It should be understood that the present invention is described with reference to models which represent assemblies having a multitude of component parts and joints which include two (2) component parts. The actual generation of the design model or assembly is conventional and well known to a designer conversant with a CAD tool software package such as Pro/Engineer.

Initially, the design model is created in Pro/ENGINEER as generally understood. That is, the design model is that which a designer generates to represent a product. The product is typically an assembly that includes a multiple of component parts and various instructions. To the design model, Joint Manager is utilized to include component annotation at part level which includes that annotation specific to a component part in the context of the assembly. Component annotation may include, for example, allowable alternates or other typically minimal detail related to the component in the context of the assembly. In other words, the component level annotation relevant to its use in the assembly.

The design model is then included in the Joint Manager container model. In the context of Pro/ENGINEER, the design model as an assembly is defined as a component in the Joint Manager container model. This allows application of the annotation with the Joint Manager container model without having an effect on the design model. This is important as the design model becomes a subassembly in the joint manger container model. The Joint Manager container model is essentially at a higher level that the design model and the design model is a subassembly within the Joint Manager container model such that any information, data, annotation or anything in the Joint Manager container model does not affect the design model (FIG. 3). The design model is only referenced thereby such that the components in the design model and thus the Joint Manager container model are always at the equivalent latest revision.

Component parts of the design model are rendered in the context of the Joint Manager container model, for example, a certain set of component parts are defined as a joint and annotation is associated with that joint—this is performed until all joints in the design model are consumed. In this way, each joint is identified as a separate entity in the Joint Manager container model referred to herein as a simplified representation of Joint Components (SimpRep). SimpReps is a capability that Pro/Engineer provides which allows, for example, an overall assembly having only particular parts defined as a SimpRep. The SimpRep includes all component parts and annotation related to the joint. For example, component parts A-D are still part of the assembly, but parts A and B (through the mechanism of the software) can be defined or tagged as a joint such that, for example, parts C and D are not active when the joint defined by parts A and B is activated.

In furtherance of this example, a design model that includes four parts A-D and three joints: one joint between parts A and B; one joint between parts B and C; and one joint between parts A and D. The design model is transferred into the Joint Manager container model. In the Joint Manager container model joints A-B, B-C and A-D are segregated (tagged) to create three SimpReps (FIG. 3). This is all done in the Joint Manager container model such that no modifications are made to the design model. So, in this example, the Joint Manager container model would contain the design model, and three SimpReps of which each is a representation of those three joints (FIG. 3).

The SimpReps use the design model as reference. That is, without the design model, there would be no component parts to build the SimpReps. Should a component part in the design model be updated, the component part in the Joint Manager container model is automatically updated. As there are often separate design teams in which one is working with the design model while another is working with the Joint Manager container model the Joint manager utilizes component parts of the latest revision.

Each SimpRep has associated annotation—lengthy text based annotation of each joint—in which annotation is customized within each one of the SimpReps. The annotation may be notes or instructions which are selected from, for example, a web based application such as EPDM notes. If EPDM Notes are not used, Joint Manager can export a template note skeleton to draft notes with a text editor or other similar tool. Annotation of drawings with notes has been found to be one of the most time consuming and error prone drawing activity. The EPDM notes library provides a full complement of notes from which a designer can select as those notes are already approved by all of the support functions. Examples of notes in the library can include notes related to: lubrication, heat treat, handle, plating, etc. Anything text based that provides instructions on how to, for example, assemble or install the joint in the product. That is, the desired pre-approved notes need only be selected from the library for automated transfer into the text based annotation of the associated SimpRep. The Joint Manager container model associates—through Joint Manager—the selected notes with the particular SimpRep.

The previously described component annotation differs from the text based annotation because component annotation is directed to the component at the design model level while the text based annotation is directed to the SimpRep. Text based annotation for the SimpRep is basically unlimited text whereas the component annotation is typically only one line of text.

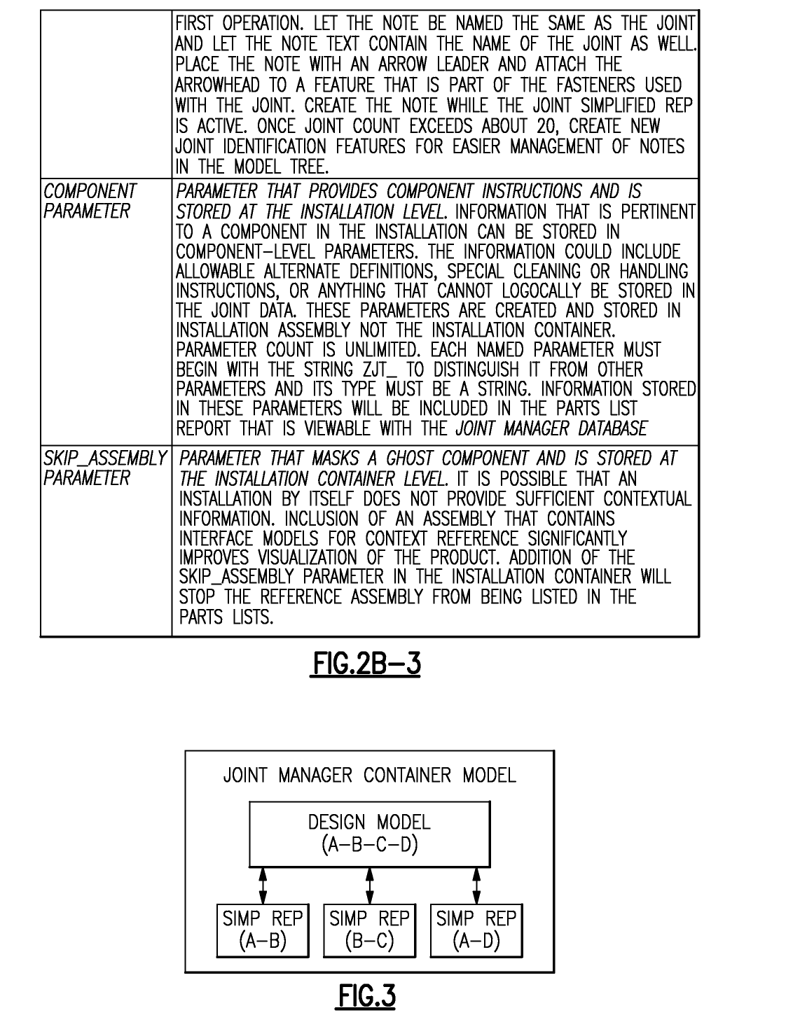

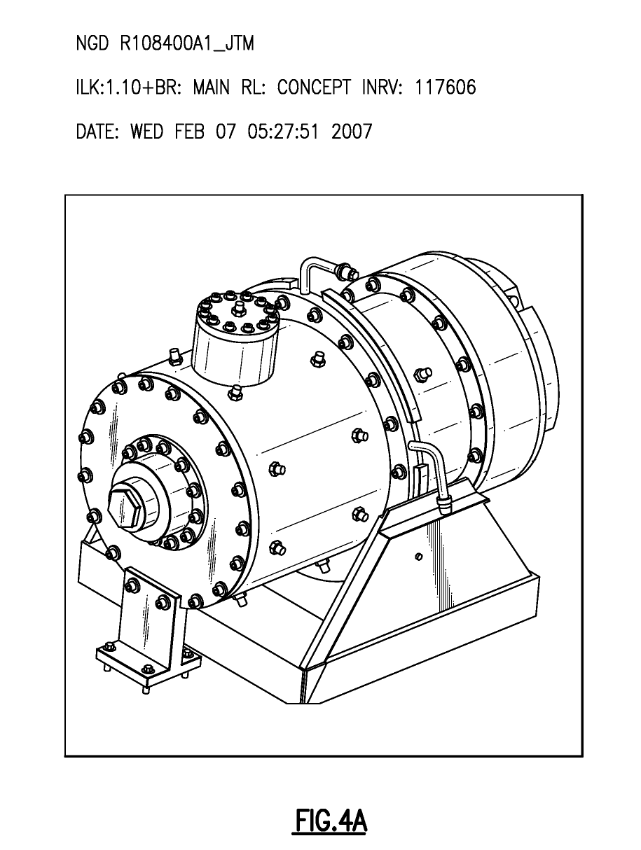

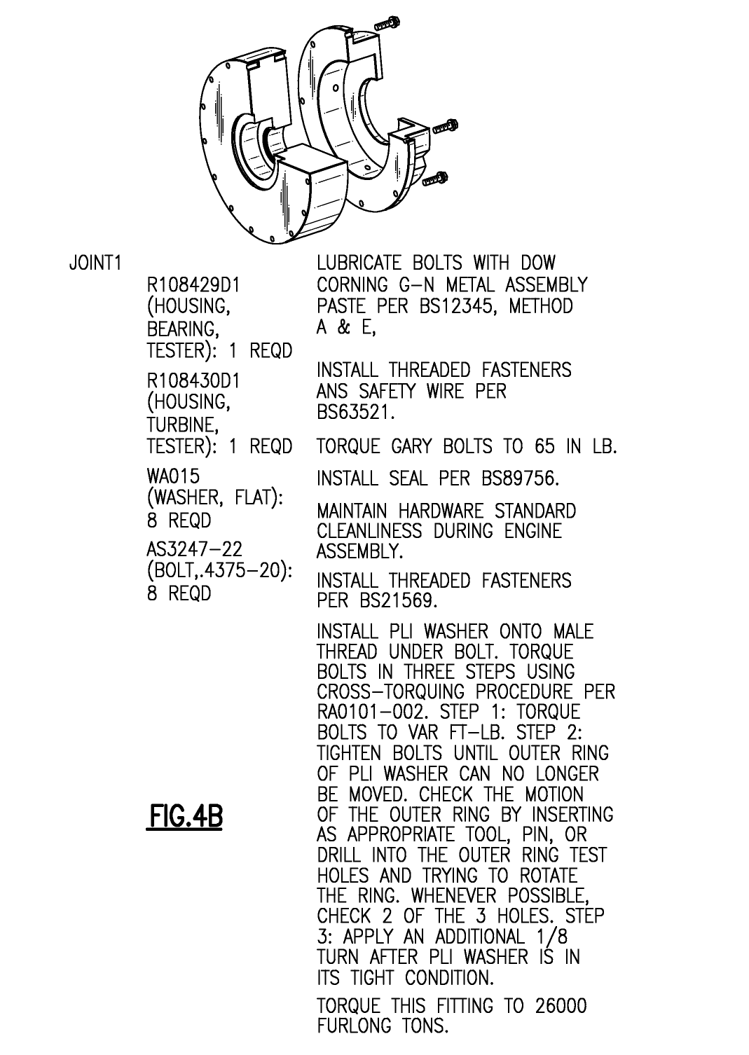

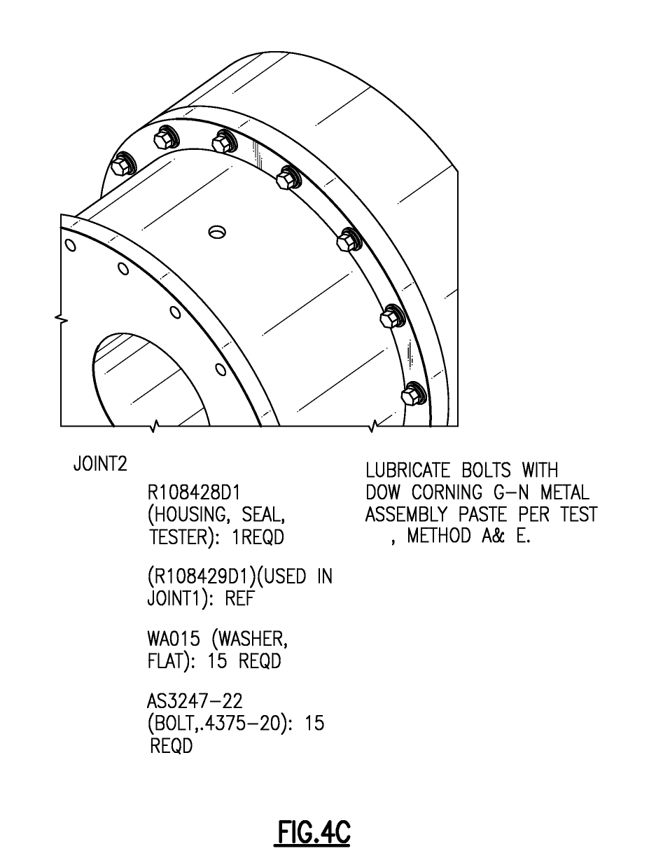

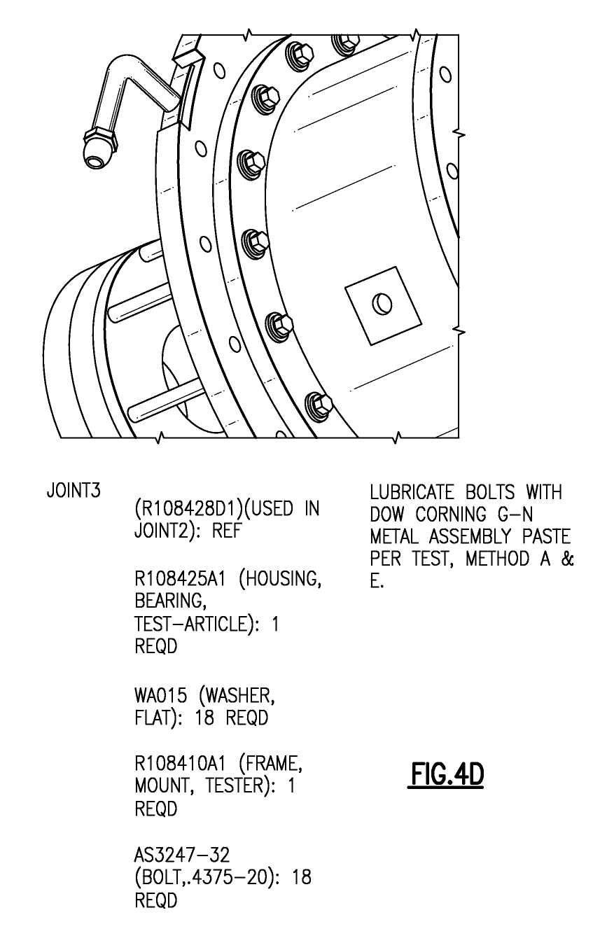

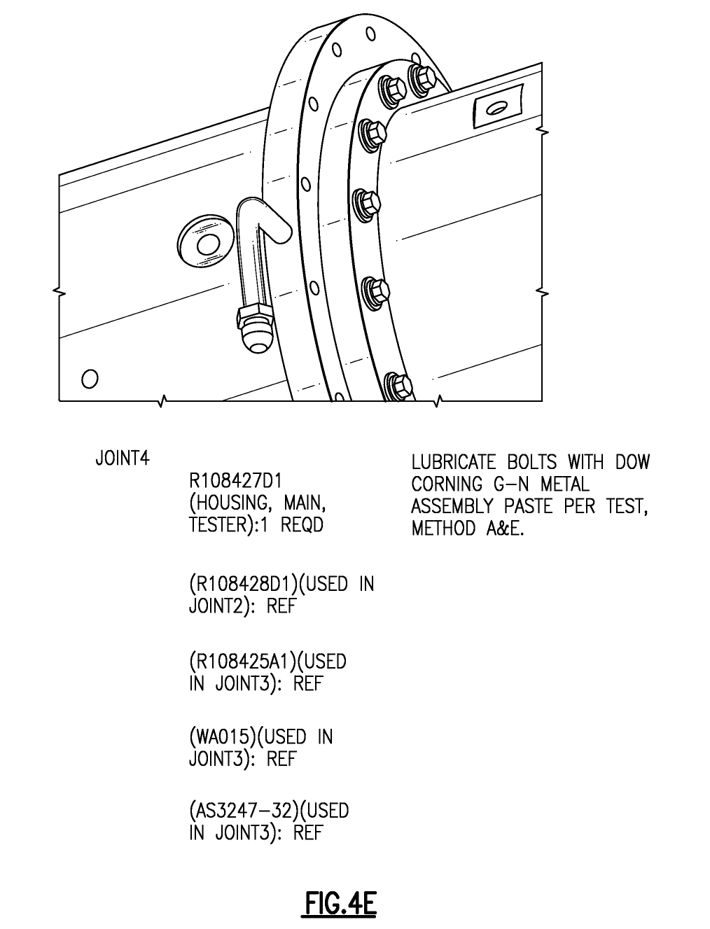

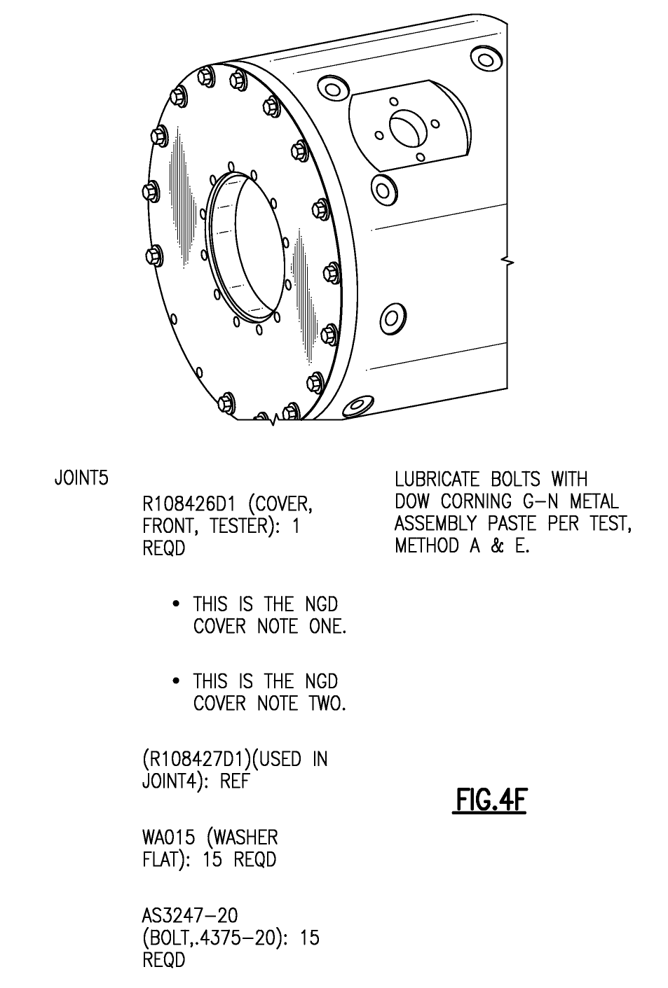

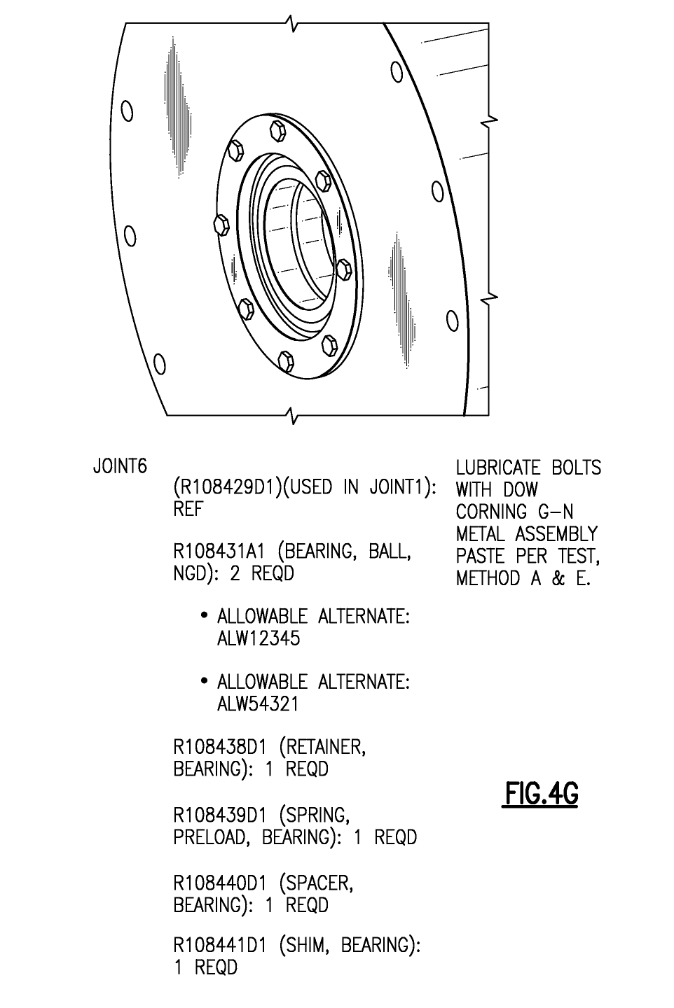

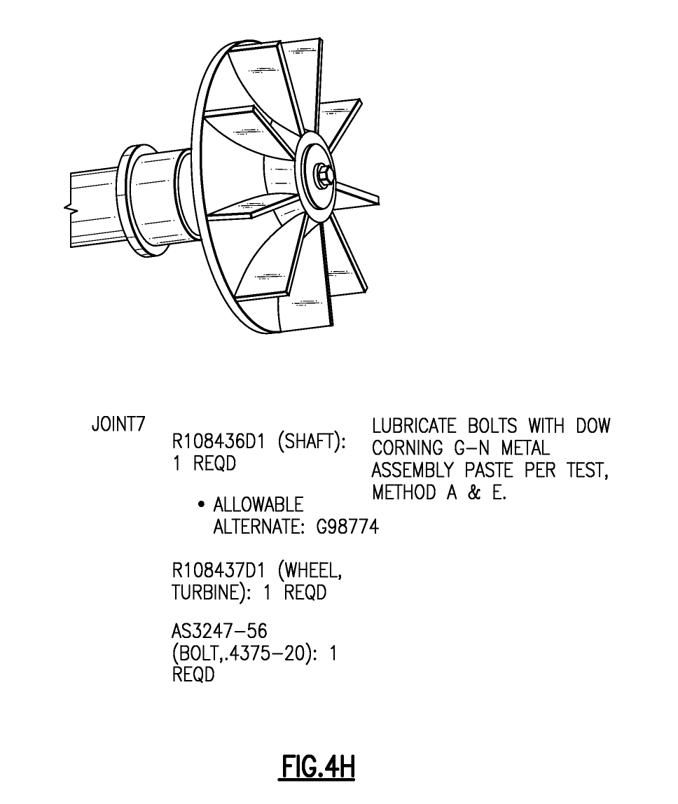

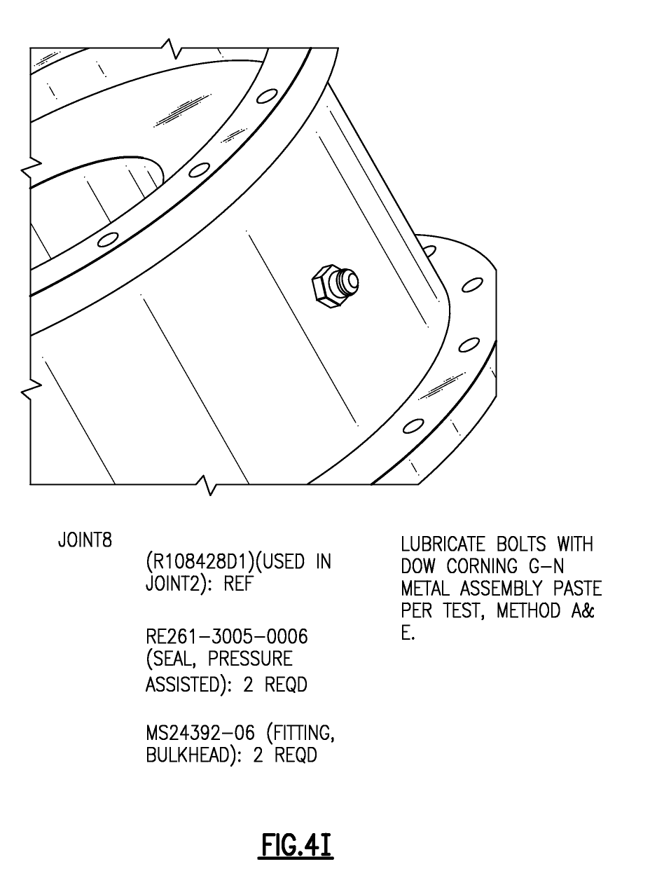

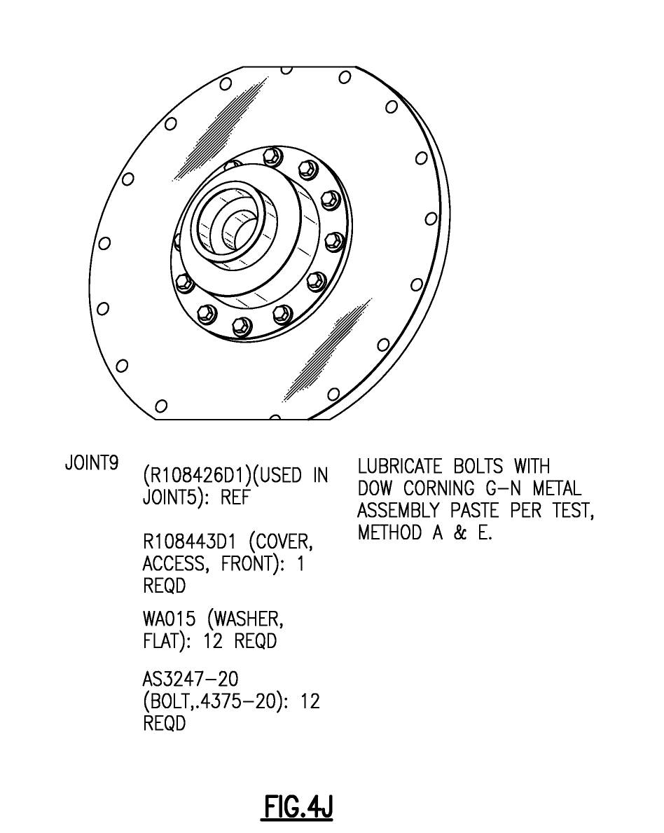

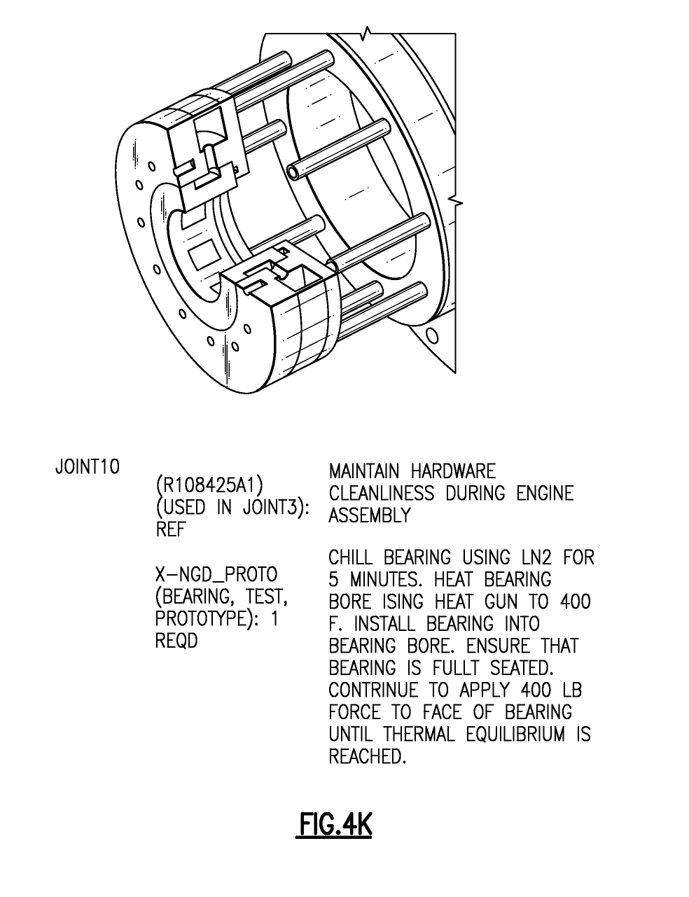

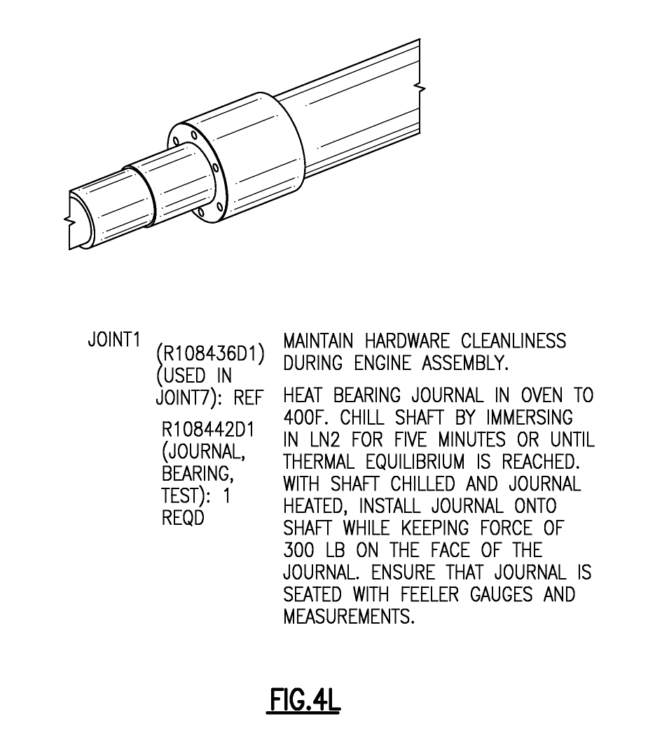

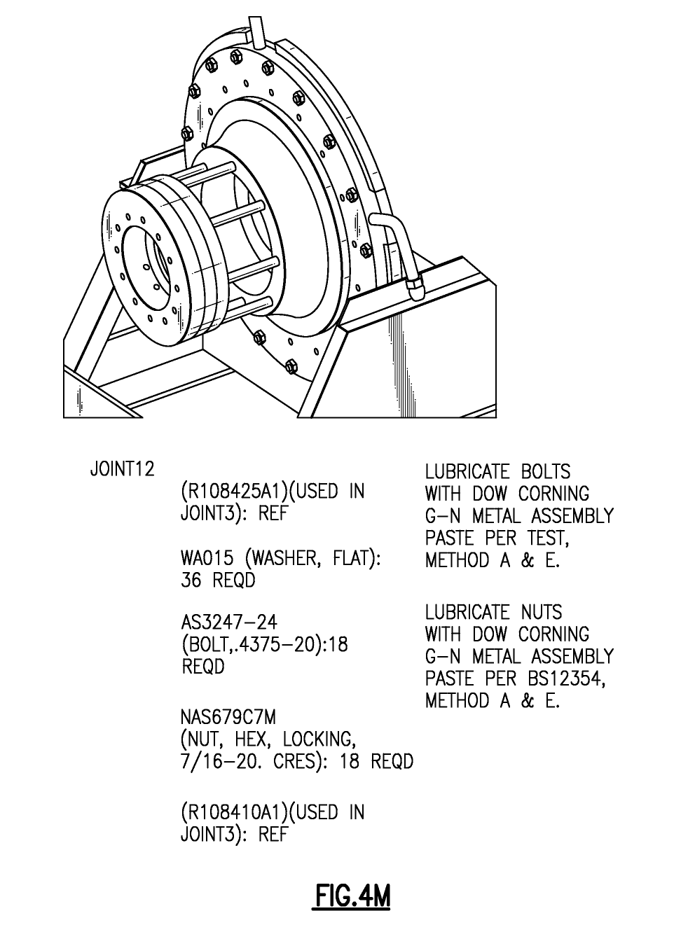

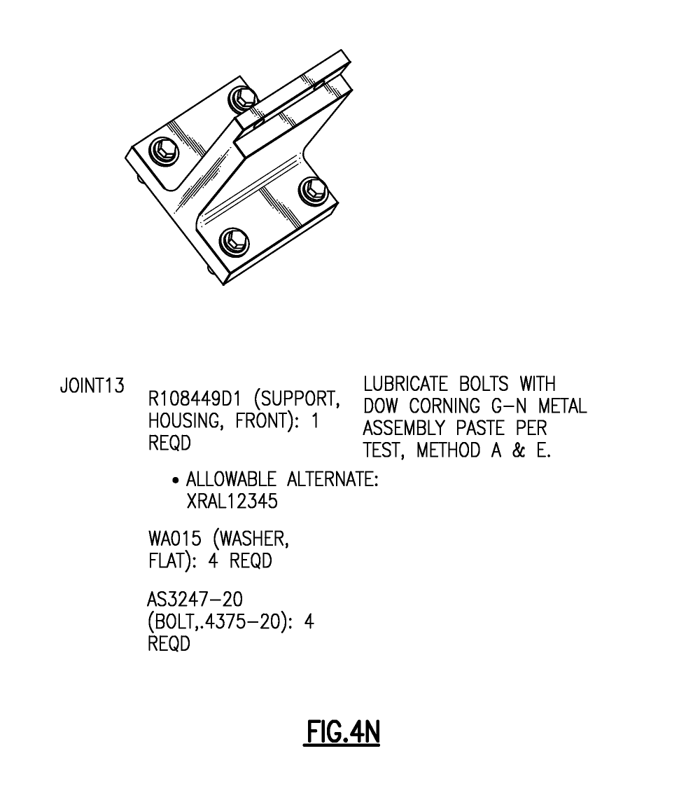

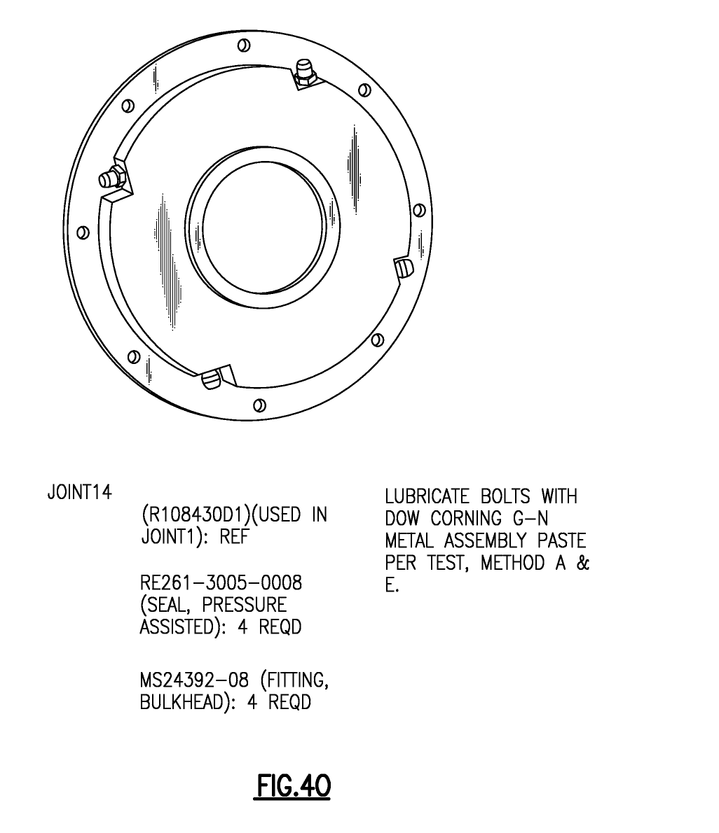

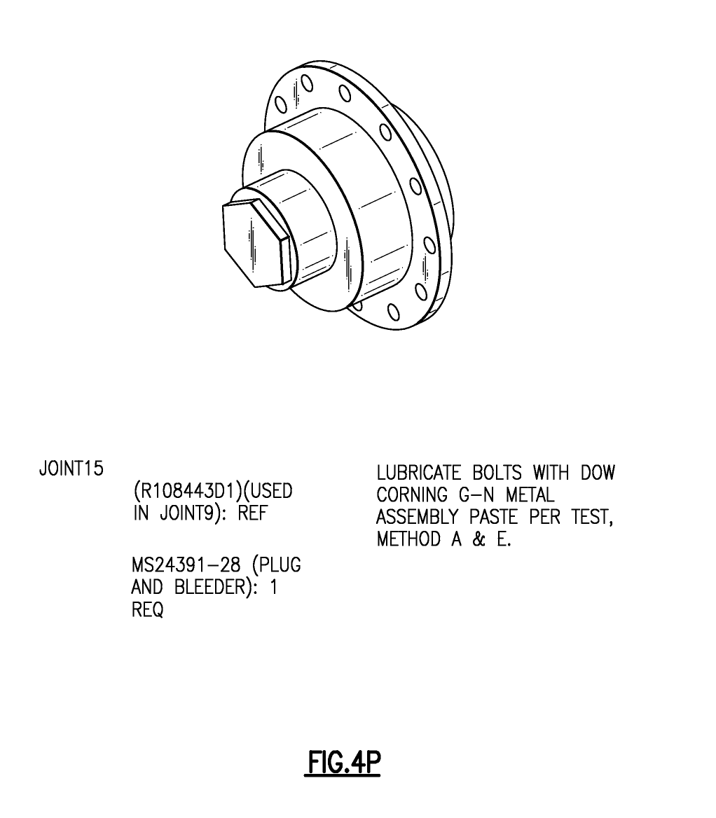

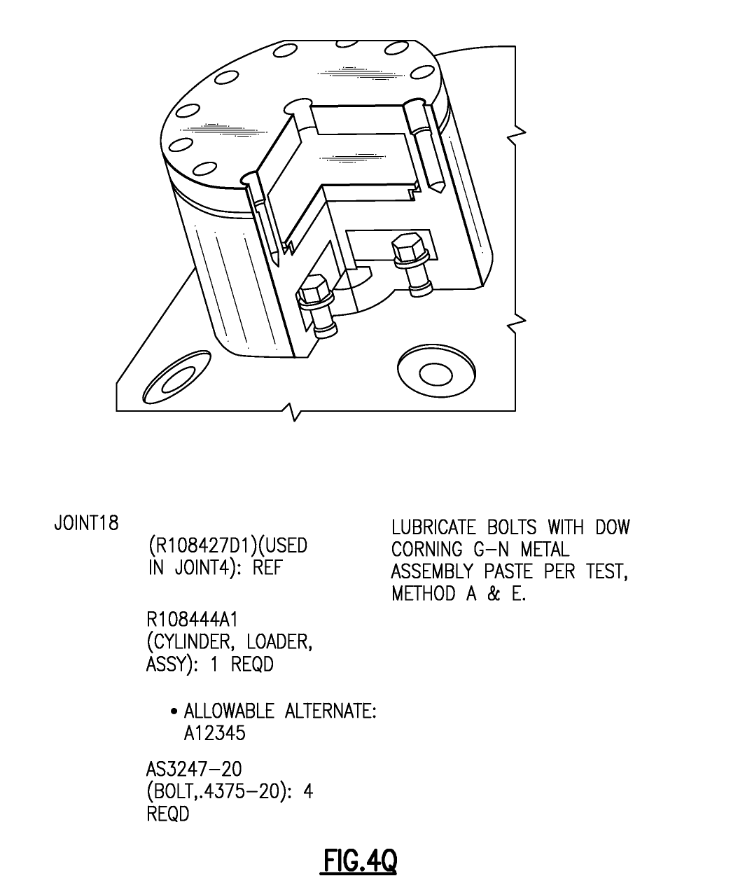

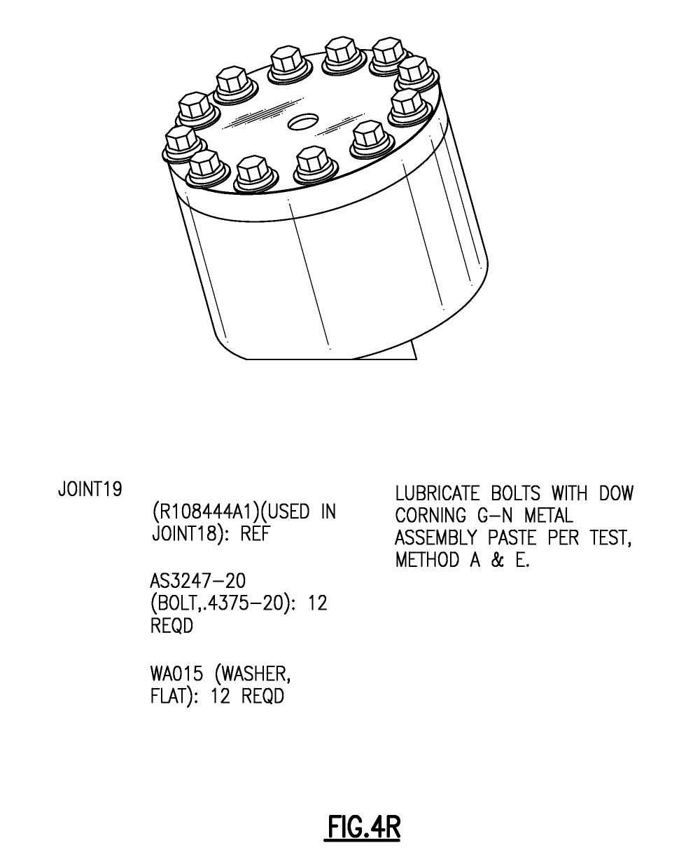

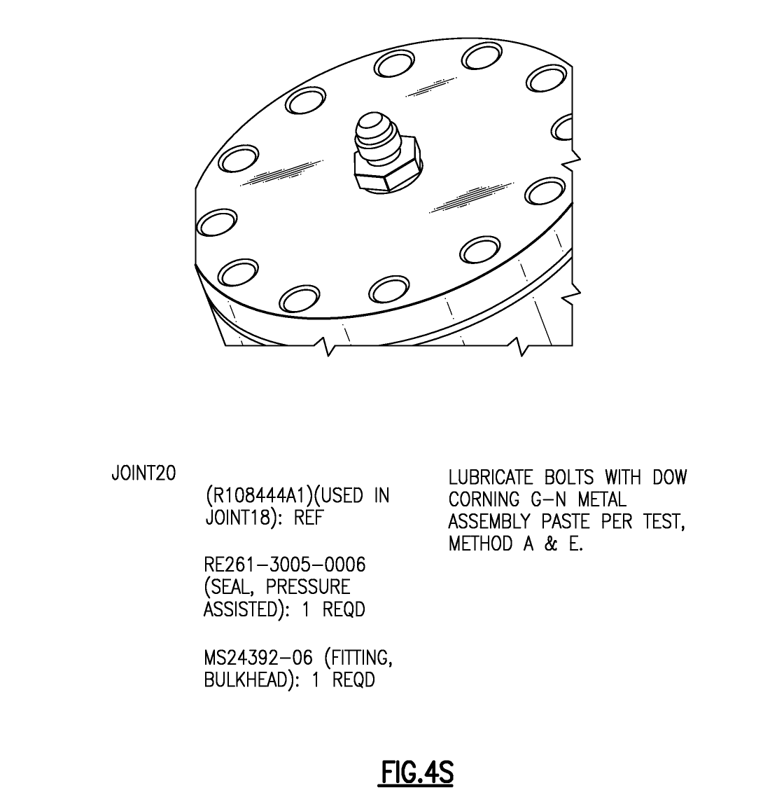

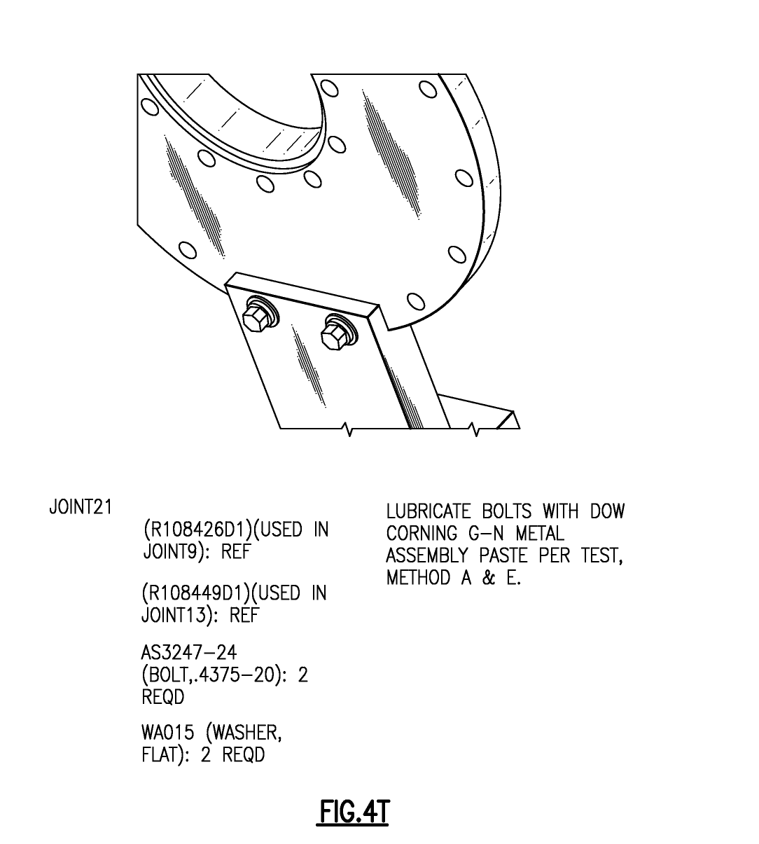

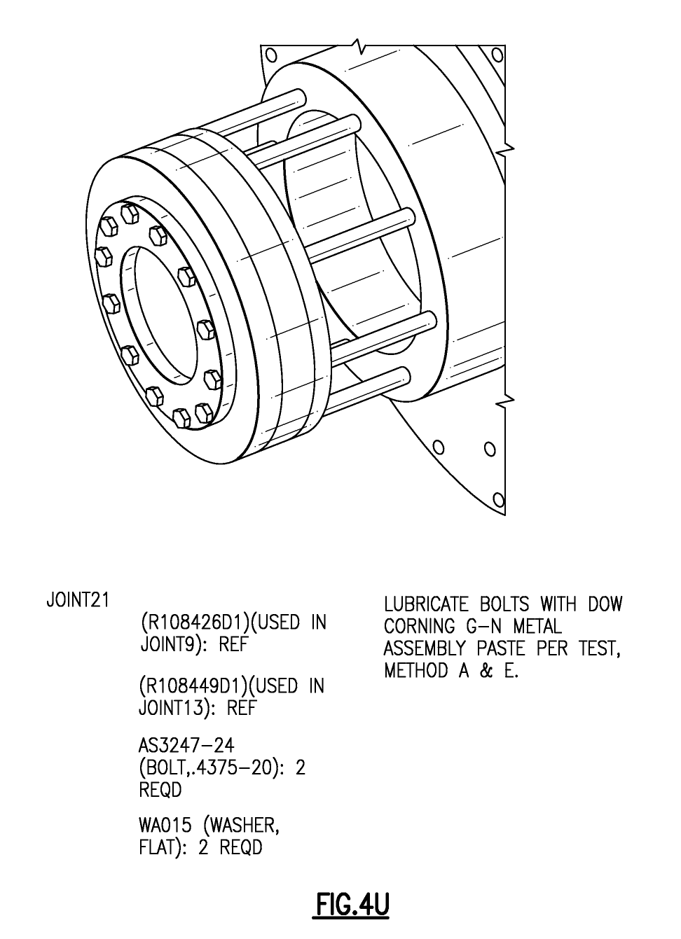

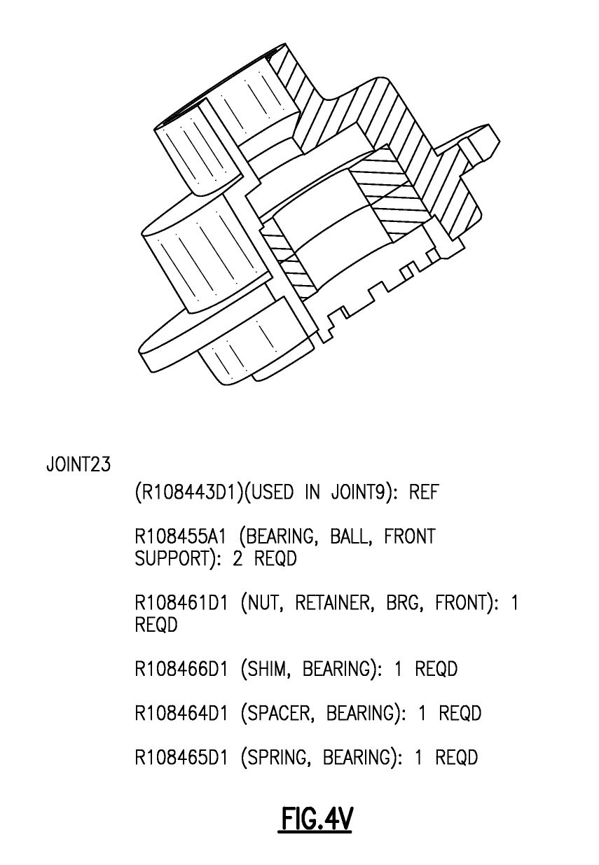

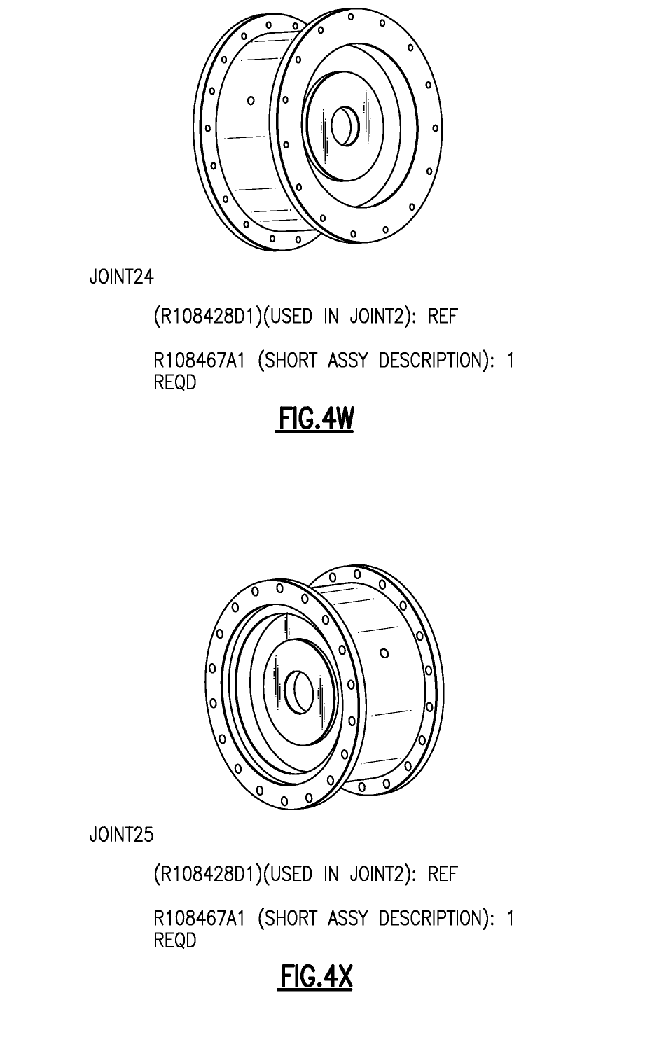

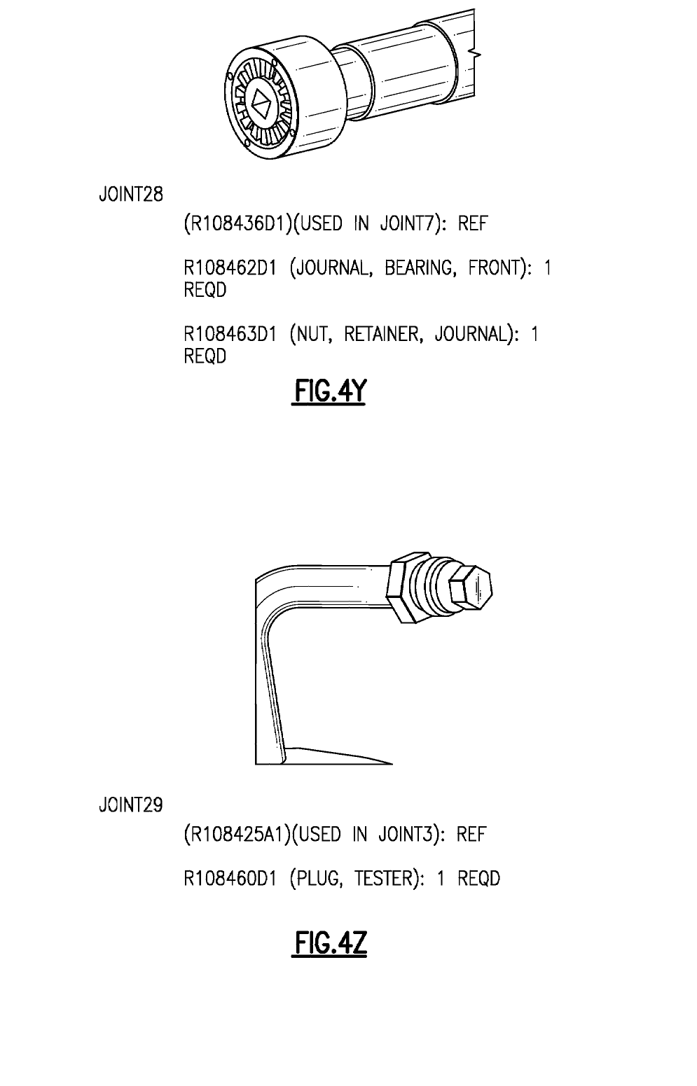

The SimpReps not only include the component parts of the joint but also graphically based annotation. Graphically based annotation is any graphical annotation such as a representation of a data plate or other 2D image such as an arrow. Graphically based annotation is a function of Pro/ENGINEER but the rendering thereof for each SimpReps is prepared with Joint Manager for presentation in a readily exportable manner. For example, Pro/ENGINEER is utilized cut a non-planar section out of a joint within the SimpRep for export to an end-user-application (see FIG. 4K). That is, because the section is non-planar and the presentation is not paper based, the image of the cut is rendered by Joint Manager for presentation in the context of the particular joint. This cut image is part of that particular SimpRep and is named in a certain way so that the Joint Manager software, when it exports the data, can associated it with the SimpRep and export it in the way the designer wants it to be exported in, for example as html or jpeg images.

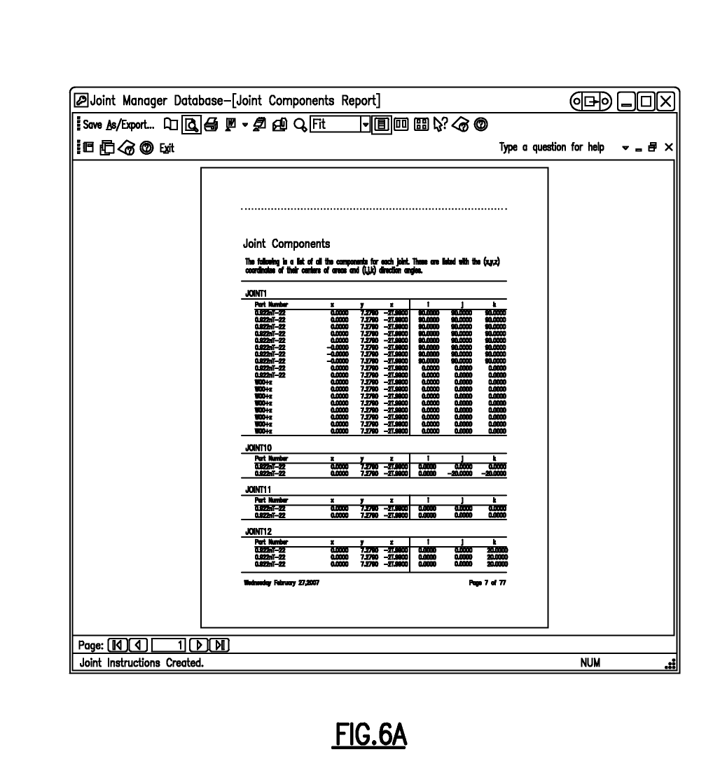

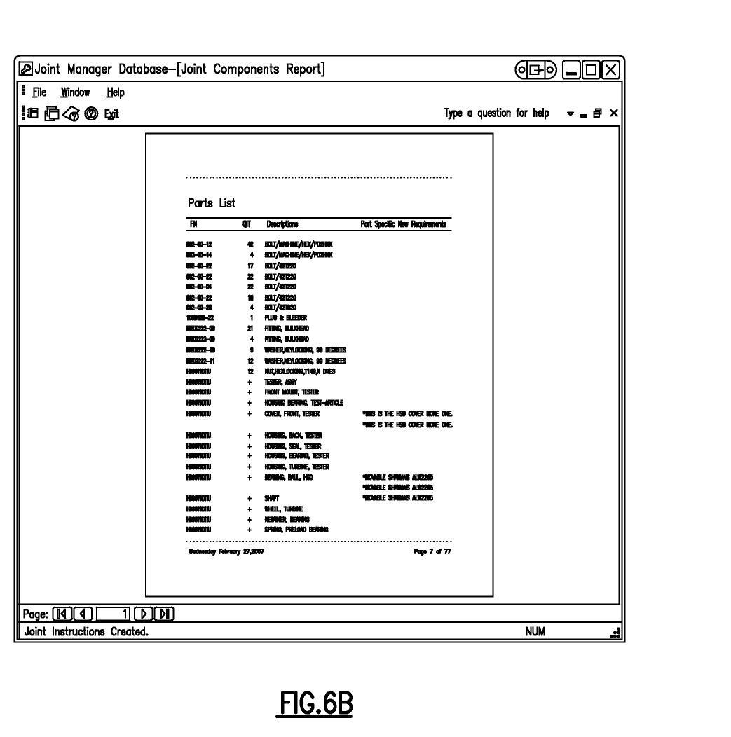

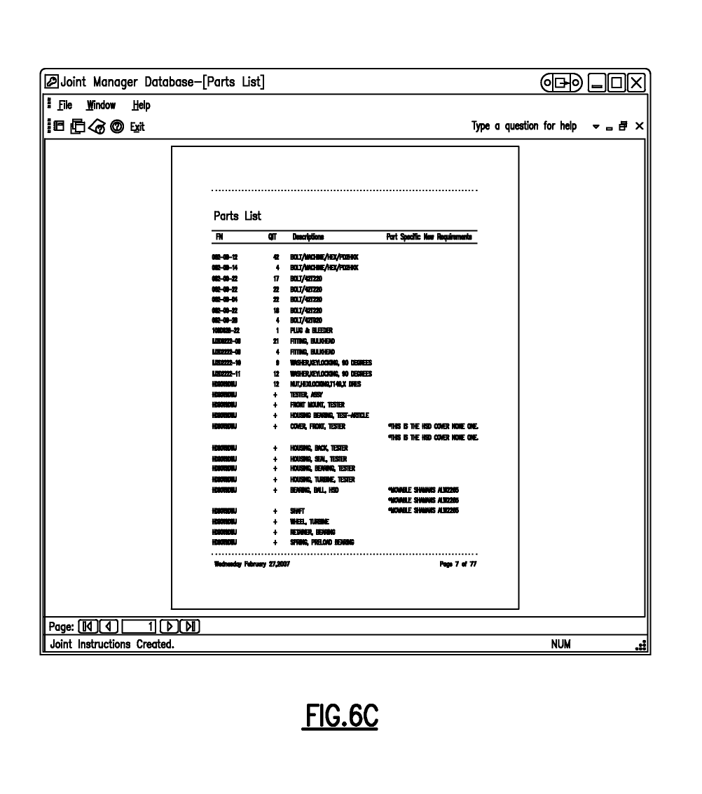

The end-user-application renders the SimpReps through a multiple of software tools such as, for example, HTML files (FIGS. 4A-4Z), database files (FIGS. 6A-6C), JPEG files, and ProductView files. The files are manipulated with standard tools found on most Windows based PC's. Neither Pro/E nor the CAD model is part of the final output package. The software tools can be in use concurrently. Static visualization of joint components shaded images and associated components are handled with the Web browser. Tabulated data that pertains to each of the joints is accessible through a database such as Access. Close scrutiny of the joint is accomplished with the ProductView viewer.

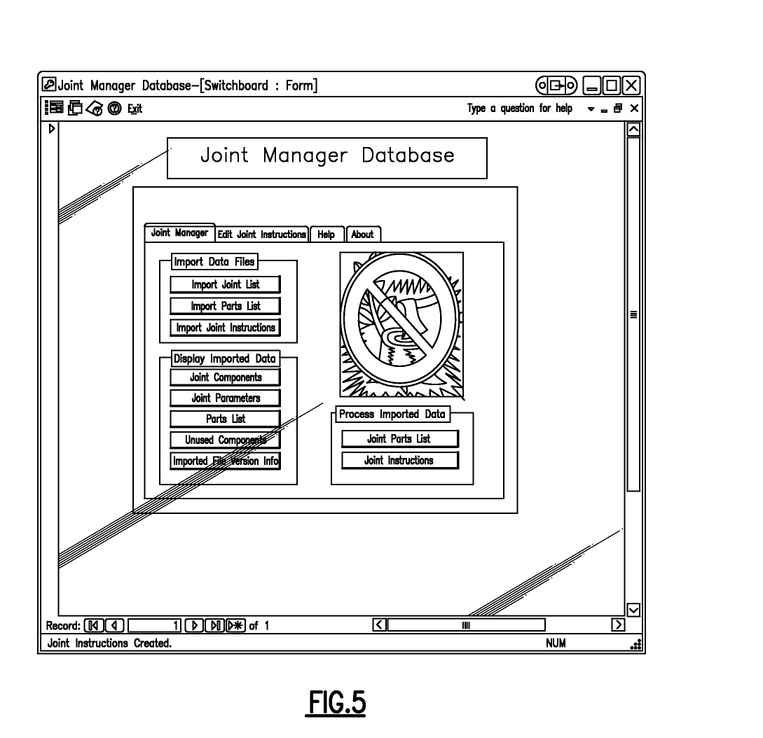

The data exported from the Joint Manager software in the disclosed embodiment is a zip file that is viewed through an end-user-application (FIG. 5). The end-user-application is essentially a shell based application which unzips the data and allows the end user to review the data. Joint instructions (notes), joint parts lists, component level annotation, and graphics images are combined in a single HTML page (FIG. 4A-4Z). The end user launches the end-user-application, and will initially review the html data (FIGS. 4A-4Z). The end user may also review the access database (FIGS. 6A-6C) to obtain another view of the data and/or Product View rendition to see the 3-D view of the data. That is, the end-user-application utilizes html which is distinguished from the designer who uses Pro/ENGINEER to prepare the data and export the data in a different form. The Export Data is zipped for use by the end user. There is no use of Pro/ENGINEER by the end user. Proprietary information such as construction approaches, equations, point clouds, and various intellectual property in the Pro/ENGINEER model is protected as the export data provides only that information required by the end user—not all the engineering information.

From within the Joint Manager software, the order of joints may be determined for exportation to HTML on the single HTML page. The order is made persistent through addition of a parameter to the joint data in the CAD file. The HTML output provides the component parts that have already been used in earlier joints include that information in their description field. For example, if a component part is listed in Joint 1 and then listed in Joint 3, Joint 1 will include descriptive information but Joint 3 will show that the component was used in Joint 1 and the quantity will not be shown. That is, the Joint Manager software tracks the specific component part was used. There are lots of cases when a part number will be used numerous times in an assembly (bolts, washers, nuts etc . . . ) but Joint Manager software will identify a specific instance and report whether it's been used and where. Couple this with the ability to control the order of joints being listed and a user can readily build a kitting system that allows planners to order components joint-by-joint without double ordering.

ProductView data is a 3-D rendition of the SimpRep models that can be manipulated and cut through to view the joints either alone or in the context of the product assembly. Current capabilities of the ProductView tool do not provide the ability to automatically generate joint visualization on a per-joint basis. An interim solution uses ProductView to navigate through the 3D rendered version of the Installation Container and uses two different custom per-joint visualization tools. One technique incorporates native Pro/E drawing capability to create per-joint visualization. The other creates JPEG files and HTML to render visualization of shaded images, joint names and components. Both the ProductView data export and the visualization creation functions are automated. Single-button-push solutions provide the designer with optimum automation and data integrity. In order for the designer to control joint visualization, views must be created and saved in the Installation Container. The views must be named the same as the Joint SimpRep. If a Joint SimpRep name is changed, the view name must be changed as well. JointManager automatically creates a saved view of the current screen and names it the same as the active SimpRep.

The end users are typically those who use current assembly and installation drawings for those who must know how to assembly the components, but don't require, or are not authorized to receive, proprietary information about those components. One such example is a technician end user about to join a turbine inlet duct to a pipeline and its mounting flange. The technician needs to understand how the joint goes together and what components are required. The end users are now, however, provided with 3D model-based definition engineering drawings which are based directly on the 3D design model as opposed to being a separately created drawing.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A computer-implemented method of defining installation and assembly requirements for a product comprising the steps of:
(A) generating a 3D design model having a multiple of component parts which define the product;
(B) defining at least one joint between at least two of the multiple of component parts;
(C) annotating the at least one joint to create a simplified representation of the at least one joint; and
(D) exporting the simplified representation in a data format different than that of said step (A).

2. The method as recited in claim 1, wherein said step (A) further comprises:
(a) generating the 3D design model in Pro/ENGINEER.

3. The method as recited in claim 1, wherein said step (A) further comprises:
(a) annotating at least one of the multiple of component parts with a component annotation.

4. The method as recited in claim 3, wherein said step (a) further comprises:
(1) including a component part alternate as the component annotation.

5. The method as recited in claim 1, wherein said step (B) further comprises:
(a) defining a joint between every two of the multiple of component parts.

6. The method as recited in claim 1, wherein said step (C) further comprises:
(a) annotating the at least one joint with a text based annotation.

7. The method as recited in claim 6, wherein said step (a) further comprises:
(1) selecting the text based annotation from a library of pre-approved notes.

8. The method as recited in claim 1, wherein said step (C) further comprises:
(a) annotating the at least one joint with a graphical based annotation.

9. The method as recited in claim 1, wherein said step (C) further comprises:
(a) cutting a non-planar section of the at least one joint to render an image included in the simplified representation.

10. The method as recited in claim 1, wherein said step (D) further comprises:
(a) exporting the simplified representation as a zip file readable by an end-user-application.

11. The method as recited in claim 10, wherein said step (a) further comprises:
(1) displaying the simplified representation as HTML data through the end-user-application.

12. The method as recited in claim 10, wherein said step (a) further comprises:
(1) displaying the simplified representation as database data through the end-user-application.

13. The method as recited in claim 10, wherein said step (a) further comprises:
(1) displaying the simplified representation as a manipulatable 3D mode data through the end-user-application.

14. The method as recited in claim 1, wherein said step (D) further comprises:
(a) exporting the simplified representation without proprietary data included in the 3D design model.

15. A computer-readable medium having stored thereon instructions for causing a computer to perform operations comprising:
(A) displaying a simplified representation of a 3D design model having a multiple of component parts which define the product in a data format different than that which created the 3D design model, the simplified representation having at least one joint between at least two of the multiple of component parts.

16. The computer-readable medium as recited in claim 15, wherein said step (A) further comprises:
(a) viewing the simplified representation through an end-user-application.

17. The computer-readable medium as recited in claim 16, wherein said step (a) further comprises:
(a) displaying the simplified representation as HTML data through the end-user-application.

18. The computer-readable medium as recited in claim 16, wherein said step (a) further comprises:
(a) displaying the simplified representation as database data through the end-user-application.

19. The computer-readable medium as recited in claim 16, wherein said step (a) further comprises:
(a) displaying the simplified representation as an annotated manipulatable 3D model data through the end-user-application.

20. The computer-readable medium as recited in claim 20, further comprising the step of:
(B) exporting the simplified representation without proprietary data included in the 3D design model prior to said step (A).
